(19) United States
(12) Patent Application Publication
(10) Pub. No.: US 2014/0274343 A1
(43) Pub. Date: Sep. 18, 2014

(54) WAGERING SYSTEM BASED ON COMMUNITY PLAY

(71) Applicant: Richard A. Herbert, Riverside, IL (US)

(72) Inventor: Richard A. Herbert, Riverside, IL (US)

(21) Appl. No.: 14/216,096

(22) Filed: Mar. 17, 2014

Related U.S. Application Data
(60) Provisional application No. 61/802,799, filed on Mar. 18, 2013.
(60) Provisional application No. 61/793,410, filed on Mar. 15, 2013.

(51) Int. Cl. G07F 17/32

(52) U.S. Cl. CPC G07F 17/3244
USPC 463/25

(57) ABSTRACT

A wagering system having a wagering base with information therein. A plurality of terminals make up a Community Play grouping. At least one processor is programmed to determine whether any wager input at any of the terminals in the Community Play grouping accessed information in the wagering base. The at least one processor additionally identifies a return for each of the players that input a wager at the Community Play grouping for a predetermined game over a predetermined time period in the event that any wager made in the Community Play grouping accessed the information. The return for each of the players is determined in relationship to the size of the wager input by each player.

### CROSS-REFERENCE TO RELATED APPLICATIONS

This application is a non-provisional of Application Nos. 61/802,799, filed Mar. 18, 2013, and 61/793,410, filed Mar. 15, 2013.

### BACKGROUND OF THE INVENTION

1. Field of the Invention

This invention relates to wagering systems and, more particularly, to a wagering system that is configured using a community play format.

2. Background Art

The modern slot machine industry is currently undergoing an explosion of innovation. Modern video graphics, animation, and sound effects, augmented by a video gaming—(non-gambling) like atmosphere and a small unit bet (1¢) have brought a new generation of younger players to an old but updated gambling device—the penny video slot machine. Very recently Historical Racing devices have entered the market that impart a slot machine experience to its players, yet are technically and legally classified as a pari-mutuel bet on a past (completed before the bet is made) horse race, or other event. This technology is described in U.S. Pat. Nos. 5,888,136 and 6,152,822 (the “Herbert Patents” incorporated by reference herein) and U.S. Pat. Nos. 6,358,150 and 6,450,889, assigned to RaceTech.

One new innovation in the slot industry aimed to promote social interaction and thus greater attendance is “Community Play”. The subject of this patent is to teach an improved methodology of Community Play which is unique and critically different from the current practice in the fixed odds industry and is non-existent in Historical Racing (no Community Play in Historical Racing exists).

Fixed odds slots now provide Community Play by physically grouping a number of machines in a close proximity array and using signage to distinguish these games. The group of players participating will mutually share some financial reward such as: should one player win a designated jackpot of, say $1,000.00, then each player in the group will win perhaps $50 to $100 also. Because the fixed odds slot is not a server-based game, it becomes virtually impossible to keep track of the individual players' bets in relation or ratio to each other's bets. Thus, the flat payment is made to whatever players are present in the grouped machines at the time a lucky winner hits a designated jackpot. The funding is simply a matter of accumulating profits from the general play of the machines and is accounted for by the overall set “take” of the machines. A popular form of awarding the community players is called the “Community Bonus Round”, the payments of which may be flat awards or some chance play within the bonus round.

### SUMMARY OF THE INVENTION

In one form, the invention is directed to a wagering system having a wagering base with information therein. A plurality of terminals is each separably usable by a player and make up a community play grouping configured so that each player at a terminal in the community play grouping is capable of identifying the presence of other players using terminals in the community play grouping. Each terminal is configured to accept a wager input by a player. At least one processor is programmed to: (a) determine whether any wager input at any of the terminals in the community play grouping accesses the information in the wagering base; and (b) identify a return for each of the players that input a wager at a terminal in the community play grouping for a predetermined game over a predetermined time period in the event that any wager made at any of the terminals in the community play grouping accesses the information in the wagering base. The return for each of the players is determined in relationship to the size of the wager input by each player.

In one form, the wagering system is configured in a pari-mutuel format.

In one form, the wagering system is configured using Historical Racing results to set up the wagering base.

In one form, the wagering system utilizes a fixed odds slot format.

### BRIEF DESCRIPTION OF THE DRAWINGS

FIG. 1 is a schematic representation of a grouping of devices operating using a Historical Racing format and interconnected through a server/processor;

FIG. 2 is a schematic representation as in FIG. 1 and showing an entire collection of wagering devices in a facility in separate groupings, all of which are managed by a central server/processor;

FIG. 3 is a view as in FIG. 1 wherein a grouping of fixed odds devices is managed by a dedicated server/processor; and

FIG. 4 is a schematic representation of a wagering system, according to the present invention.

### DETAILED DESCRIPTION OF THE PREFERRED EMBODIMENT

The inventive wagering system provides features to enhance play for patrons that are not available in the current state of the art in the fixed odds slot industry and is wholly lacking in Historical Racing. It is helpful to initially describe application of the invention to Historical Racing and its pari-mutuel process and then describe a methodology that could be used to apply the invention to the fixed odds slot industry.

When large lottery progressive carryover pool jackpots accumulate, many people form ad hoc groups to “pool” their money to give their group a greater overall chance of success, albeit each individual of the group gets a lesser but pro rata share to divide should the group succeed. The tradeoff is worth it, obviously, as many such ad hoc groups form when such large jackpots accumulate. One potential advantage of this invention is to provide that environment on the gambling floor where Historical Racing/pari-mutuel devices are. But even better than the ad hoc groups that exist for lotteries, this invention allows, automatically, for even complete strangers to legally form such groupings. With lotteries such groups usually consist of those who know each other—for example, those in a workplace environment—and should such a group win a large lottery jackpot there is often much legal arguing as to the relative shares of the group, if not outright attempts at theft of proceeds by some of the group's individuals.

With the present invention, the server-based Historical Racing devices are preferably grouped and advertised via signage where any individuals may so sit—friends and/or complete strangers. The advertised, usually progressive, jackpot is known to the players and at the appropriate time each sitting player of the group sees on their individual video screen a message asking the individual if they would like to compete for the prize. Then messages asking the players, individually, how much they would like to risk is flashed, the players respond, and then the screen tells each individual player how much has been accumulated to play the game and each individual player's exact pro rata share of any jackpot that each would win if their group ultimately proves successful. The game conducts over a specified period of time over which the group's accumulated funds are trialed against the probability of winning the jackpot. Should the group succeed, the server legally apportions each player's share and then the prize is processed. If taxes become an issue, each player's tax information is taken and each player receives, pro rata, their individual share. The overall effect is to create a unique environment on the gambling floor that creates opportunity for increased socialization. This should lead to increased attendance at the venues offering this unique play. Every night the environment on the floor will offer this exciting, social style of play which has already been demonstrated by the ad hoc lottery pools that occur now. But it is better in this instance, as the players can feel comfortable doing so even with virtual strangers, and do not have to worry about legal entanglements as they are assured that the state that licenses the venue stands behind the player receiving his/her fair share if they should win. One must understand that social interaction may very well be a significant factor at increasing the attractiveness of a venue for players where a great deal of industry competition exists now and no doubt will increase in the future. This invention aims to increase that attractive aspect to the gambling floor.

The inventive concept is particularly suitable to be used in conjunction with what was originally disclosed in provisional patent application Ser. No. 61/793,410, filed Mar. 15, 2013, incorporated herein by reference, that has as its subject progressive play. The use of this invention can be superimposed on any pari-mutuel device (and for that matter could be used in conventional live racing) play such as Historical Racing, and, as explained below, can be adapted to fixed odds slot machine play.

For the Historical Racing format, ideally, perhaps 15-20% of all total games on a floor could be grouped physically, but also scattered groups could be linked in, say, groups of 6 to 10 machines that are labeled as community play but are not spatially in close proximity to each other. For games that are spatially in proximity to each other, a box or semi-circle arrangement could be utilized. Regardless of the exact arrangement, the separate devices are linked together through a server/processor 10, as shown for eight (8) exemplary devices in FIG. 1.

The most easily useable games for community play would be progressive carry over jackpots (see provisional patent application 61/793,410, filed Mar. 15, 2013 and incorporated herein by reference) that might be played once a night for perhaps 25-55 minutes. If no one wins this jackpot in the time allotted, then it might replay (with the increased jackpot growing) the next day at an appointed time. More than one of these would ideally be going on throughout the day and night on the gambling floor, allowing for multiple daily attractions. Each player gets to decide if they would like to play and each player gets to decide how much to wager (e.g. 1¢ to perhaps $50 for the game period). Then they see their group betting sum in total, and their individual contribution with their pro rata percentage share of the group's winnings, if any, at the end of the game. They also would watch the progress of their group's combined “bankroll” being wagered over the course of the time span allotted for the specific (usually progressive) jackpot they are participating in. Each player's bet would be accounted for on their game screen credits section. Ideally, the group's total sum wager would be timed to last for the duration of the progressive jackpot being contested. In other words, a group betting $150 total, over a 55 minute time span for a progressive jackpot offered would see, if the unit bet were 1¢, 15,000 1¢ bets take place at a rate of 4.545⁺1¢ bets per second for the entire 55 minutes the progressive jackpot is offered. If another group had a pool of $75 total they would watch their pool be bet against the progressive jackpot at a rate of 2.273⁻1¢ bets per second for the entire 55 minutes.

Alternatively, a group's entire bankroll could be wagered, 1¢ or whatever a minimum bet would be designated at, all at once or virtually the minimum bet played as fast as could be processed by a high speed computer—within a second or a few seconds—allowing the group to re-form another group bankroll composed of each player's new contribution. In such a manner Community Play would take place by this new methodology using a pari-mutuel method in Historical Racing devices. Each player is monitoring the group play on their own screens and is responsible for deciding when and how much to wager into the group pot.

Of note is the fact that the above methodology will be consistent with pari-mutuel rules and is uniquely different from current fixed odds slot Community Play. Here, each player is paid proportionally to his/her bet made and everyone, if they win, gets the exact same pro rate payout. Fixed odds pays the big winner his/her prize and a nominal amount is paid to all others in the community. There is no pro rata pooling of the player's money and no separate group contesting to win a large pari-mutuel jackpot and no pro rata distribution of winnings. Further, with this new methodology, a player (using one preferred embodiment) is vested for an extended time span—unlike fixed odds where the Community Play takes place sporadically over an undetermined period. Also with the invention, if a player leaves in the middle of play, the processor/server is able to keep track of the leaving player and account their winnings, if they occur, to that player's individual identifying account number, which allows the player to pick up any winnings at a later date. (This is not possible with current fixed odds slots nor any Historical Racing devices now existing. A fixed odds player leaving the machine is immediately withdrawn from play.) Finally, this invention allows players the ability to dictate their own terms of how much to bet. With fixed odds slots the players participating have to keep up with the betting, because if they are not betting actively when another player hits a jackpot that would pay them a nominal amount, they are out of luck. With the inventive system, players could have left the game, yet still win as their bet was already made and is played out for them whether or not they are even at the device when/if the bet wins.

The methodology also allows for the player to privately play the same progressive jackpot as well as contributing to the community pro rata pot. When they privately play the progressive, the entire jackpot is available to them should they win, and they also have another chance at it via the Community Play aspect. Of note is that this progressive play aspect is contemplated as only a “sideshow” to the regular games being offered on the Historical Racing devices. This is because these high jackpot progressives are rarely won and the gambling floor cannot be consigned to only be playing a game where nearly every bet loses. So regular lower odds games, that more frequently win, are offered all the time along with the progressives. (This is because the fixed odds industry combines everything into a chip, a processor, and a random number generator, while Historical Racing has separate pools for each bet and must organize differently. It is more complex, but that complexity allows its players greater choice and control of their wagering.) The progressive game/Community Play games add an incentive and a time period for the players to “dream” while they are occupied with the entertaining regular games offered on the Historical Racing devices. This psychology is the same that drives lottery sales—the dream of a life-changing win. The combination of socializing via Community Play, the dream of a big win, with an economical way to play through community bet pooling, along with regular game frequent winners is a combination that should prove successful for Historical Racing. The Community Play is likely to add greatly to the experience to make Historical Racing successful.

The adaptation to fixed odds slots is accomplished as follows. In order to use this kind of Community Play—let's call it “pro rata contribution and pro rata division of winnings” to distinguish it from the Community Play that currently exists in the fixed odds slot industry and is described above. With respect to the fixed odds slot devices, two different adaptations are described herein. First, the simplest way to do so is to allow fixed odds slots to become a server-based game, which currently is not allowed legally. With a server-based methodology, fixed odds slots could implement a pro rata contribution, pro rata winnings division methodology while maintaining fixed odds methods. The difference between the pari-mutuel version, outlined above, and this possible fixed odds version is that in the pari-mutuel method the chance to win the pending jackpot has a time period defined by how long the pari-mutuel pool containing the funds stays open to be played. If during that time span more than one win occurs, then the net pool prize fund would be divided equally between all the winners, and in the case of a community group being one or more of those winners, then the individuals within that group would be rewarded pro rata in accordance with each player's original contribution to the total funds expended by that community group in achieving that win. For example, you may see two individual winners and one community group.—all three entities achieving a win during perhaps a 45 minute play period. (Playing or wagering period is defined by the life of the Horse Racing consistent pari-mutuel pool in Historical Racing. With Fixed Odds Devices there may or may not be a defined timed wagering period. With a timed wagering period, there could be a multiple (possible) winner pari-mutuel pool more or less consistent with the manner in which such pools are conducted within conventional racing, without a timed wagering period, the pool generally would be paid wholly to a single first winner.) If $1,500,000 was in the pool to be paid, then $500,000 would go to each of the individual player winners and $500,000 to the one community group winner. Then the $500,000 to the one community group would be further divided to the members of that group pro rata to the original money contribution of each member of the group. In the case of this adaptation to fixed odds slots, a server is needed to keep track of the details involved in creating these community groups (in a fixed odds environment) because without a server, the individual fixed odds slots could not keep track of the details needed to play in this Community Play manner. The progressive jackpot would play continuously without a time frame until the first individual or a first community group successfully hits the jackpot. In the community group case, the timing to “spend” the group's accumulated funds would not be timed to the pool's length of life because no such pool time span exists. But rather, the life of the Community Play funds could be played out very quickly (or played more slowly over several minutes, as the operators wish).

In this manner, there would be only a single winner, either an individual or a group formed by the above methodology. Alternatively, to allow multiple winners, a pari-mutuel pool with a time period would need to be formed and applied onto the fixed odds device. With a time period the fixed odds device could continue play until the time period ends, thus allowing multiple winners which would allow for a pari-mutuel division of the pool to all winners within the timed period.

Second, as another way to adapt Community Play to fixed odds, the slots could remain non-server based and in this case the grouping of machines constituting Community Play could (for each group of machines) be connected to either a separate small, one function auxiliary computer/server managing all the groups or ever smaller servers individualized to each manage one or two groups. These small servers/computers then could keep track of each group's members and their respective money contributions and then the system would perform just as the first method described above. The small auxiliary servers would not manage the regular fixed odds slot functions but would be confined/dedicated to manage the member accounting, pro-rata contributions, and payments, and tax implications of any wins within the Community Play functioning.

In a fixed odds format, an entire floor of devices could be connected by a central server/processor 12, as seen in FIG. 2. In the depicted embodiment, the server/processor connects to three groupings, each made up of eight paired devices. (1-8; 9-16; 17-24) that may be all Community Play devices or a mix of both Community Play and non-Community Play devices.

In an alternative fixed odds format, a dedicated server/processor can be used for the community plan devices, shown at 1-8 in FIG. 3. The dedicated server/processor manages only Community Play functions.

A dedicated server/processor, such as the dedicated server/processor 14, may manage several or all facility Community Play machine groupings in the same manner as depicted from the single grouping in FIG. 3. The advantage of Community Play using the pro rata prize divisions, is that it provides a more attractive draw for player participation and socialization than the current methodology used by fixed odds slots to conduct Community Play. Community Play is non-existent now in Historical Racing.

In FIG. 4, a wagering system, according to the present invention, is shown in schematic form at 16. The schematic representation is intended to encompass virtually a limitless number of different component variations, and interactions thereof, that may be used according to the inventive concepts to operate generally as described above.

The wagering system consists of a wagering base 18 having information 20 therein.

A plurality of terminals 22, 24 each is separably usably by a player to collectively make up a Community Play grouping configured so that each player at a terminal 22, 24 in the Community Play grouping is capable of identifying the presence of other players using terminals 22, 24 in the Community Play grouping. The number of terminals 22, 24 is not limited to any specific number. Two terminals 22, 24 are shown for purposes of simplicity.

Each terminal 22, 24 is configured to accept a wager which through an input 26, 28, respectively, is caused to be processed to potentially access information 20 in the wagering base 18.

At least one processor 30 is programmed to: (a) determine whether any wager input at any of the terminals 24, 24 in the Community Play grouping accessed the information 20 in the wagering base 18; and (b) identify a return for each of the players that input a wager at a terminal 22, 24 in the Community Play grouping for a predetermined game over a predetermined time period in the event that any wager made at any of the terminals 22, 24 in the Community Play grouping accessed the information 20 in the wagering base 18. The return for each of the players is determined in relationship to the size of the wager input by each player.

The foregoing disclosure of specific embodiments is intended to be illustrative of the broad concepts comprehended by the invention.

1. A wagering system comprising:
a wagering base having information therein;
a plurality of terminals each separately usable by a player and making up a community play grouping configured so that each player at a terminal in the Community Play grouping is capable of identifying the presence of other players using terminals in the Community Play grouping,
each terminal configured to accept a wager input by a player; and
at least one processor programmed to: (a) determine whether any wager input at any of the terminals in the Community Play grouping accessed the information in the wagering base; and (b) identify a return for each of the players that input a wager at a terminal in the Community Play grouping for a predetermined game over a predetermined time period in the event that any wager made at any of the terminals in the Community Play grouping accessed the information in the wagering base, the return for each of the players determined in relationship to the size of the wager input by each player.

2. The wagering system according to claim 1 wherein the wagering system is configured on a pari-mutuel format.

3. The wagering system according to claim 1 wherein the wagering system is configured using Historical Racing results to set up the wagering base.

4. The wagering system according to claim 1 wherein the wagering system utilizes a fixed odds slot format.
